(19) United States
(12) Patent Application Publication
(10) Pub. No.: US 2009/0302063 A1
(43) Pub. Date: Dec. 10, 2009

(54) Dosing Device for a Fluid

(76) Inventors: Wilhelmus Johannes J. Maas, Someren (NL); Petrus Lambertus W. Hurkmans, Someren (NL)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/160,561

(22) PCT Filed: Feb. 13, 2007
(86) PCT No.: PCT/NL07/00040

§ 371 Date: Oct. 27, 2008

(30) Foreign Application Priority Data
Feb. 13, 2006 (NL) 1031135

(51) Int. Cl. B67D 5/06; B65D 37/00; G01F 11/28

(52) U.S. Cl. 222/205; 222/438; 222/207; 222/211

(57) ABSTRACT

The invention relates to a device for dosed dispensing of a quantity of fluid from a container, comprising:—a dosing member (3) which is in fluid connection with the container and which has a number of outlet openings debouching in a dosing chamber (4), and—a control member (6) connected fluid-tightly to the dosing member and having a control opening, wherein the control member (6) and the dosing member (3) are displaceable, for instance rotatable, relative to each other for placing the outflow openings and the control openings in register with each other for the purpose of defining different dosages. This dosing device is provided with an intermediate container (8) placed between the dosing chamber and the container and having a retention volume which is at most equal to the volume of the dosing chamber, this intermediate container being in fluid connection with the container and the dosing member. The intermediate container (8) limits the quantity of fluid which can reach the dosing chamber (4) from the container (2), thereby preventing excessive fluid being dispensed.

The invention relates to a device for dosed dispensing of a quantity of fluid from a container, comprising a dosing member which is in fluid connection with the container and which has at least one outlet opening debauching in a dosing chamber, and a control member connected fluid-tightly to the dosing member and having at least one control opening, wherein the control member and the dosing member are displaceable, in particular rotatable, relative to each other for placing the outflow opening(s) and the control opening(s) in register with each other for the purpose of defining different dosages. Such a dosing device is known from the Netherlands patent 1011477.

In this text the term fluid is understood to mean any non-gaseous flowing medium, thus liquids as well as finally distributed, solid substances in powder form.

Said earlier patent application describes a dispensing cap for a squeeze-bottle which is filled with liquid and provided with a dosing chamber formed integrally with a bottle, for instance by injection moulding followed by blow-moulding. The dosing chamber has a bottom with an opening therein and a cylindrical rise tube which is directed therefrom toward the interior of the bottle and which is in turn connected to an immersion tube protruding into the bottle. Placed in line with the rise tube on the bottom of the dosing chamber is a dosing tube which is likewise cylindrical and has a series of outlet openings formed at different heights. These openings are arranged distributed not only in height direction but also in peripheral direction. Protruding into this dosing tube is a control tube which is likewise cylindrical and provided with a channel recessed into its cylinder wall and which is fixed to a rotatable cover closing the dosing chamber. The control tube and the dosing tube are rotatable relative to each other.

By rotating the cover, and therewith the control tube, a chosen outlet opening of the dosing tube can be placed in register with the channel of the control tube. If the bottle is now squeezed, the liquid will then be pushed upward through the immersion tube into the rise tube and will subsequently flow into the channel in the cylinder wall of the control tube. From here the liquid flows through the outlet opening of the dosing tube into the dosing chamber. When the pressure on the squeeze-bottle is removed, the liquid will, owing to the underpressure in the interior of the bottle, be sucked back out of the dosing chamber through the outlet opening, the channel, the rise tube and the immersion tube. This return suction of the liquid is ended the moment air is drawn in. This will be the case when the relevant outlet opening of the dosing tube comes above the liquid level in the dosing chamber. The choice of the height of the outlet openings which are placed in register with the channel thus determines the liquid level which will remain in the dosing chamber after release of the squeeze-bottle and which can then be poured out and used.

This earlier dosing device, which enables dosing of liquids in simple manner and with relatively great accuracy, can for instance be used to administer feed or medication to animals and to measure off required quantities of cleaning agents and the like.

A drawback of the known dosing device is that there is a risk of excessive fluid being dispensed unintentionally. This can occur when the bottle is squeezed so hard that so much fluid enters the dosing chamber that it as it were “overflows”.

The invention now has for its object to improve a dosing device of the above stated type such that this risk is obviated, or at least reduced.

According to the invention this is achieved in such a dosing device by an intermediate container placed between the dosing chamber and the container and having a retention volume which is at most equal to the volume of the dosing chamber, this intermediate container being in fluid connection with the container and the dosing member. Such an intermediate container limits the quantity of fluid which can reach the dosing chamber from the container, whereby the risk of “overflow” is thus eliminated in effective manner. This is of course advantageous for an accurate dosage. This is particularly important when the content of the container is harmful to humans or the environment, and unintentional outflow thereof therefore involves a health hazard.

Preferred embodiments of the dosing device according to the invention are described in the dependent claims.

The invention is now elucidated on the basis of an embodiment, wherein reference is made to the accompanying drawing, in which:

FIG. 1 is a schematic perspective view of the dosing device according to the invention in the closed starting position,

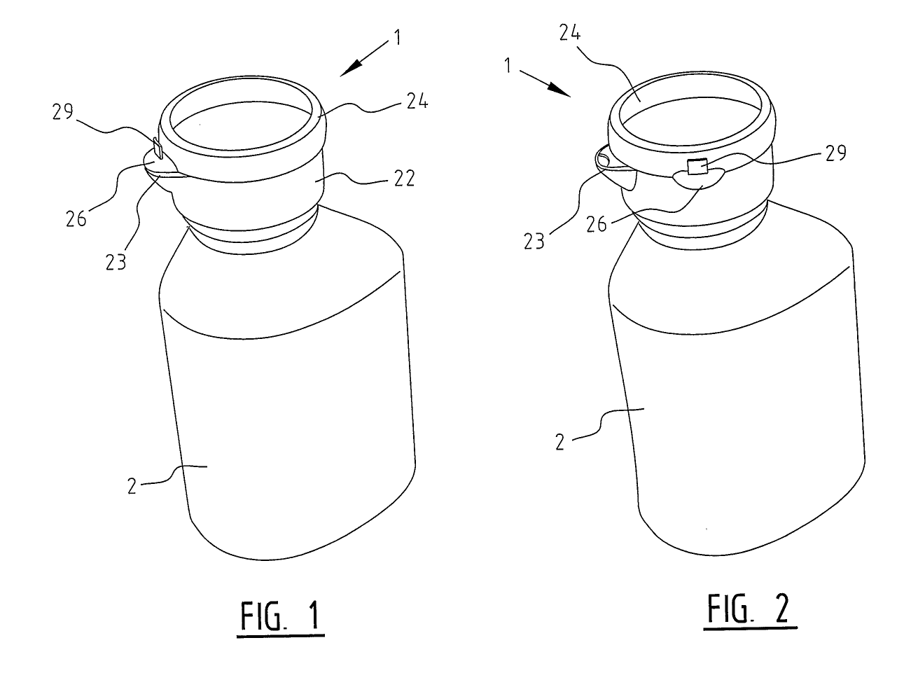

FIG. 2 is a view corresponding to FIG. 1 of the dosing device in opened, ready-to-use position,

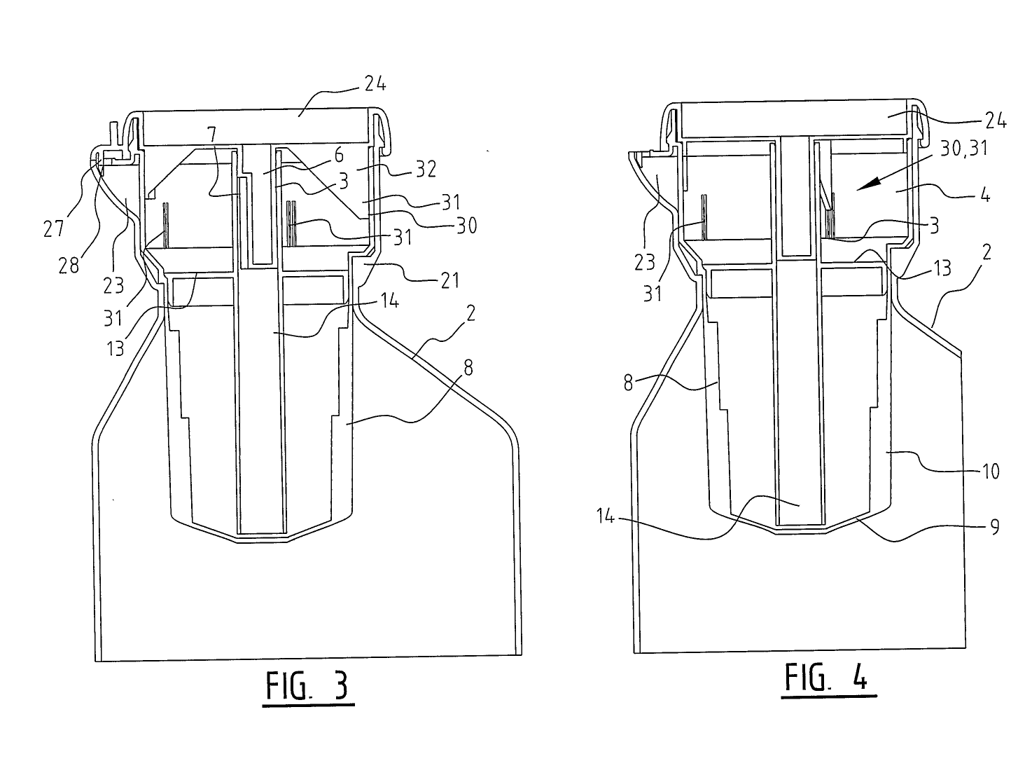

FIG. 3 is a longitudinal section through the dosing mechanism of the dosing device of FIGS. 1 and 2 in the closed starting position,

FIG. 4 is a view corresponding to FIG. 3 of the dosing device in the opened position of FIG. 2,

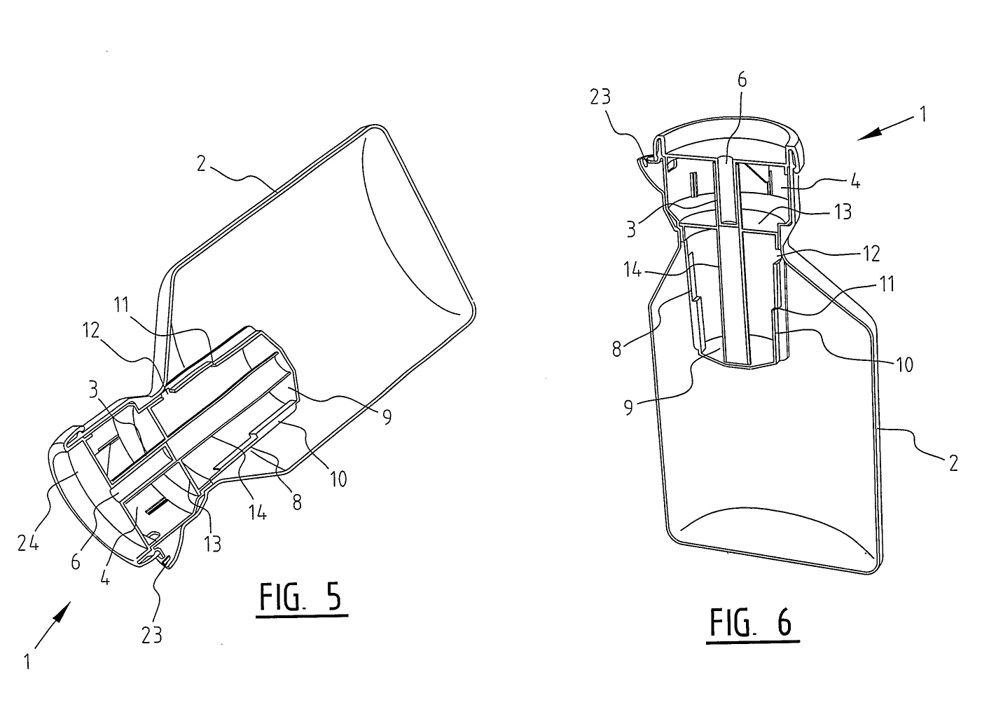

FIG. 5 is a perspective longitudinal section of the dosing device during dispensing of fluid from the dosing chamber,

FIG. 6 is a view corresponding to FIG. 5 of partial emptying of the intermediate container,

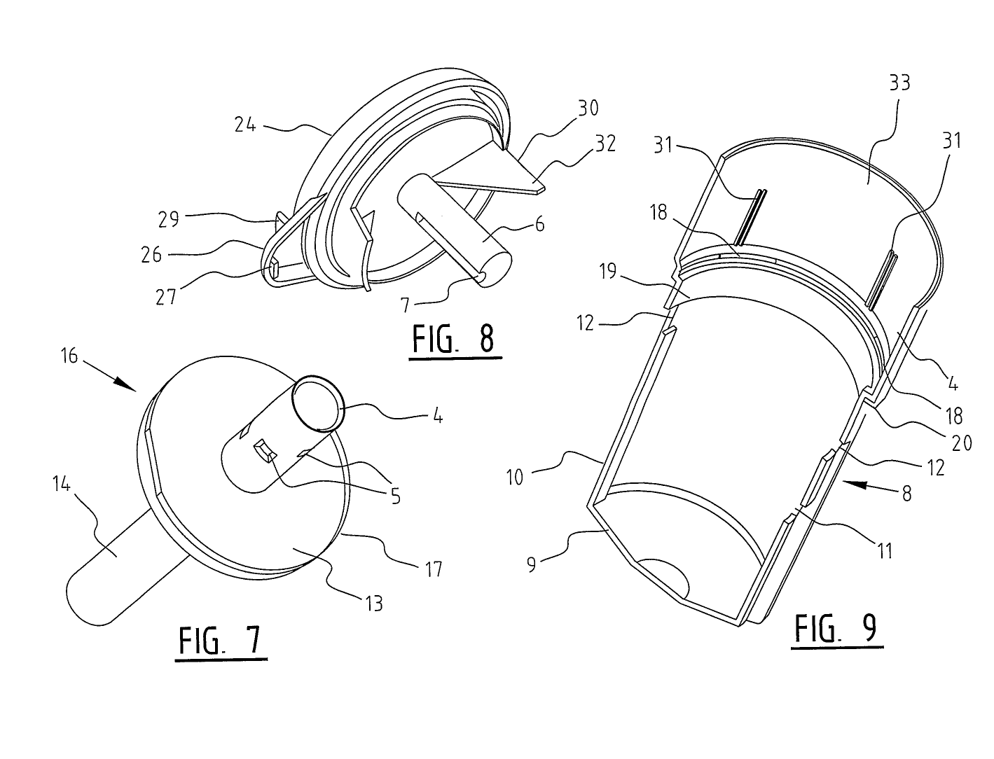

FIG. 7 is a perspective top view of the bottom of the dosing chamber, the dosing member integrated therewith and the rise tube integrated therewith,

FIG. 8 is a perspective bottom view of the cover closing the dosing chamber and control member integrated therewith, and

FIG. 9 is a cross-sectional perspective view of the cup-like intermediate container.

A device 1 for dosed dispensing of a quantity of fluid from a container 2 comprises a dosing member 3 which is in fluid connection with container 2 and which has a number of outlet openings 5 debauching into a dosing chamber 4. These openings 5 are arranged distributed not only in longitudinal direction of dosing member 3 but also in its peripheral direction. Dosing device 1 further comprises a control member 6 connected fluid-tightly to dosing member 3 and having a control opening 7 embodied as channel. Control member 6 and dosing member 3 are displaceable, in the shown embodiment rotatable, relative to each other so that a chosen outlet opening 5 can be placed in register with control opening 7 in order to define a dosage to be dispensed, as will be elucidated below. It is otherwise also possible to envisage the dosing member 3 and control member 6 being displaceable relative to each other in other manner, for instance being slidable in lengthwise direction.

According to the invention there is placed between dosing chamber 4 and the interior of container 2 an intermediate container 8 which has a retention volume which is at most equal to the volume of dosing chamber 4. This intermediate container 8 is in fluid connection with both the interior of container 2 and the dosing member 3. Intermediate container 8 is here cup-shaped and has a bottom 9 and a cylindrical side wall 10 extending from bottom 9. Formed in this side wall 10 is an emptying opening 11 which bounds the retention volume. Also formed in side wall 10 of intermediate container 8 are filling openings 12 which are located at a greater distance from bottom 9 than emptying opening 11.

In the shown embodiment dosing member 3 is fixed to the bottom 13 of dosing chamber 4, and even formed integrally therewith. Conversely, control member 6 is rotatable in dosing chamber 4, more particularly received in dosing member 3. Dosing member 3 is further connected to or formed integrally with a rise tube 14 extending in intermediate container 8.

Bottom 13 of dosing chamber 4 closes an open side 15 of intermediate container 8 remote from the bottom 9 of intermediate container 8. In the shown embodiment dosing chamber 4 and intermediate container 8 are formed integrally. Component 16 forming the bottom 13 of dosing chamber 4 and also carrying dosing member 3 and rise tube 14 is here snapped fixedly with its peripheral edge 17 by means of protrusions 18 onto a shoulder 19 in the combined dosing chamber and intermediate container 4, 8.

Intermediate container 8 in turn rests with a peripheral edge 20 on a shoulder 21 defined by a neck 22 of container 2. This neck 22 has an outlet opening 23 in fluid connection with the interior of dosing chamber 4.

Control member 6 is suspended from a cover 24 which is clamped round an upper edge 25 of neck 22 and which closes dosing chamber 4. In the shown embodiment control member 6 is even formed integrally with cover 24 in order to minimize the number of separate components. Cover 24 is provided with a protruding beak-like part 26 which closes outlet opening 23. This beak-like closure 26 and outlet opening 23 are provided with child protection locking means in the form of a protrusion 27 on beak 26 which engages in an opening 28 in the edge of outlet opening 23. The locking is released by urging a lip 29 on the upper side of the beak-like closure 26 toward the peripheral edge of cover 24.

Cover 24 and dosing chamber 4 further have in this embodiment co-acting stops 30, 31 for tactile indication of the position of rotatable cover 24 relative to the dosing chamber. Stop 30 on cover 24 forms the end edge of a part 32 protruding inward into dosing chamber 4, while stops 31 in dosing chamber 4 are distributed in peripheral direction over the inner wall 33 thereof.

The operation of dosing device 1 is as follows. Prior to first use dosing device 1 is turned over once. Fluid hereby flows out of container 2 to intermediate container 8. During use cover 24 is first unlocked by operating the lip 29 and then rotated to a desired dosing position which is indicated by the co-acting stops 30, 31. A visual indication of the different positions, for instance in the form of markings, can otherwise also be present on the outer side of dosing device 1 and/or container 2.

Container 2 is then squeezed, whereby the pressure in container 2 and in intermediate container 8 increases and fluid is carried out of intermediate container 8 via rise tube 14 and the channel-like control opening 7 to outlet opening 5 of dosing member 3, which is at that moment in register with control opening 7. As long as container 2 is being squeezed fluid will thus flow through outlet opening 5 into dosing chamber 4. The maximum amount of fluid reaching the dosing chamber 4 is herein limited by the active volume of intermediate container 8, which is in turn bounded by the emptying opening 11 at some distance from bottom 9.

When container 2 is released an underpressure is created therein, whereby fluid is suctioned back out of dosing chamber 4 into intermediate container 8. This return suction continues until air is drawn in via outlet opening 5, a sign that the level of the liquid in dosing chamber 4 has dropped as far as outlet opening 5. Container 2 can then be turned over, whereby the fluid is dispensed from dosing chamber 4 via outlet opening 23. In this position of container 2 fluid flows simultaneously through filling openings 12 into intermediate container 8. When container 2 is placed upright once again, the fluid flows out of intermediate container 8 again through emptying opening 11 until the level has dropped below emptying opening 11. The volume of intermediate container 8 below this opening 11 is the active volume, and may not be greater than that of dosing chamber 4.

A structurally simple dosing device is thus obtained with which a desired quantity of fluid can be dosed accurately without risk of fluid overflowing from the dosing chamber.

Although the invention has been elucidated above on the basis of an embodiment, it will be apparent that it is not limited thereto and can be varied in many ways within the scope of the following claims.

1. A device for dosed dispensing of a quantity of fluid from a container, said device comprising:
(a) a dosing member which is in fluid connection with the container and which has at least one outlet opening debauching in a dosing chamber, and
(b) a control member connected fluid-tightly to the dosing member and having at least one control opening,
wherein the control member and the dosing member are displaceable, relative to each other for placing the outlet opening and the control opening in register with each other for the purpose of defining different dosages, and
(c) an intermediate container placed between the dosing chamber and the container and having a retention volume which is at most equal to the volume of the dosing chamber, said intermediate container being arranged between the container and the dosing member and in fluid connection therewith.

2. The device according to claim 1, wherein the intermediate container is cup-shaped and has a bottom and at least one side wall extending from the bottom,
wherein at least one emptying opening which bounds the retention volume is formed in the side wall.

3. The device according to claim 2, comprising at least one filling opening which is formed in the side wall of the intermediate container and which is located a greater distance from the bottom thereof than the emptying opening.

4. The device according to claim 1, wherein the dosing member is fixed to a bottom of the dosing chamber and the control member is accommodated rotatably in the dosing chamber.

5. The device according to claim 4, wherein the dosing member is formed integrally with the bottom of the dosing chamber.

6. The device according to claim 4, wherein the dosing member is connected to a rise tube extending in the intermediate container.

7. The device according to claim 6, wherein the rise tube is formed integrally with the bottom of the dosing chamber and the dosing member.

8. The device according to claim 4, wherein the bottom of the dosing chamber closes an open side of the intermediate container remote from the bottom thereof.

9. The device according to claim 4, wherein the dosing chamber and the intermediate container are formed integrally.

10. The device according to claim 1, wherein the control member is connected to a cover at least partially closing the dosing chamber.

11. The device according to claim 10, wherein the control member is formed integrally with the cover.

12. The device according to claim 10, wherein the dosing chamber has at least one outlet opening and the cover bears means for closing thereof.

13. The device according to claim 12, wherein the cover and the dosing chamber have co-acting means for child protection locking of the dosing device.

14. The device according to claim 10, wherein the cover and the dosing chamber have co-acting stops for indicating at least one dosing position.
